(19) United States
(12) Patent Application Publication
(10) Pub. No.: US 2004/0199468 A1
(43) Pub. Date: Oct. 7, 2004

(54) Sheet handling apparatus

(76) Inventors: Muneharu Nakabayashi, Owarlasahl (JP); Akira Mori, Owarlasahi (JP); Mitsunari Kanou, Seto (JP)

Correspondence Address: MCDERMOTT, WILL & EMERY, 600 13th Street, N.W., Washington, DC, 20005-3096, US

(21) Appl. No.: 10/763,391

(22) Filed: Jan. 26, 2004

(30) Foreign Application Priority Data
Mar. 14, 2003 (JP) 2003-069287

(51) Int. Cl. G06F 17/60

(52) U.S. Cl. 705/43

(57) ABSTRACT

An object of the present invention is to increase a capability to determine bills determined as unidentified to improve a truth determination capability. A sheet handling apparatus of the present invention comprises: a detector that detects a characteristic of a sheet transported by a transport module; an amplifier that amplifies a signal obtained from the detector; an A/D converter that converts an analog signal amplified in the amplifier to a digital signal; determining means that determine the truth of the sheet by use of a signal having been produced as a result of A/D conversion by the A/D converter; and a control part that changes signal read accuracy of the detector. If a sheet is determined as unidentified in the determining means, the control part changes an amplification factor or resolution of the detector so that a capability to determine the sheet is higher, and the truth determination of the sheet is performed again.

### BACKGROUND OF THE INVENTION

### Field of the Invention

The present invention relates to a sheet handling apparatus, and more particularly to improvement in truth determination capability in automatic teller machines (hereinafter referred to as ATM), automatic exchange machines, and other machines handling bills.

A sheet handling apparatus such as ATM usually handles plural types of bills and determines the denominations and truth of the bills in a determining unit. Bills determined as false in the determining unit are ejected from the machine and returned to the user so that it is not captured by the ATM. This has been a conventional practice. On the other hand, there has been an increasing demand for a system which does not return False bills to users to identify the users of the False bills and hold the used False bills as evidence. A circulation-type ATM uses bills inputted from users as bills for payment and requires less maintenance operations such as addition of lacking bills and withdrawal of bills from a bill stocking chamber, in comparison with a non-circulation-type ATM. To improve the use efficiency of the circulation-type ATM, it is desirable to use bills inputted to the machine as bills for payment whenever possible, but at the same time it is necessary to avoid the output of False bills, requiring improvement in the capability to determine the truth of bills.

This type of technology is disclosed in Japanese Published Unexamined Patent Application No. Hei 10-302112 (Reference 1). According to the technology, when a bill is determined as false by a determining part, the bill is not rejected and determined again after the speed of transporting the bill is decreased.

According to the technology disclosed in Japanese Published Unexamined Patent Application No. 2000-348234 (Reference 2), a terminal for a medium determining system is provided with a simple truth determining means, which transfers the data for determining the truth of a medium to a host computer to perform detailed truth determination.

### SUMMARY OF THE INVENTION

However, the technology of the Reference 1 has a problem in that, since the speed of transporting the bill is decreased to perform redetermination, more time is required for processing. The technology of the Reference 2 has a problem in that, since bill input processing in the terminal is terminated for detailed determination by the host computer, much time is consumed before the redetermination is performed.

A conceivable method for solving such problems is to use the same determining method used in a host computer in terminals so that the terminals perform detailed determination. In this case, for the denominations of bills that can be inputted to a bill input port, or the denominations of bills received by at least sheet handling apparatus, truth determination must be performed without fail, and it is desirable to widen the range (hereinafter referred to as a dynamic range) of signals to be sensed to get the characteristics of sheets used for determination. However, if a dynamic range is widened when an identical A/D converter is used, the unit of quantizing signals may become larger, and it may become more difficult to get detailed characteristics of sheets, in comparison with the case of narrower dynamic ranges.

An object of the present invention is to provide a sheet handling apparatus that can accurately determine the truth of sheets.

Another object of the present invention is to increase the capability to determine bills determined as unidentified as a result of determining the truth of bills to improve the truth determination capability.

The present invention is constructed so that, if sheets are determined as unidentified as a result of truth determination in a determining part, the settings of the amplification factor or resolution of a detector is changed to increase the capability to determine the truth of the sheets, and the unidentified sheets are again subjected to truth determination in the determining part.

Specifically, a sheet handling apparatus of the present invention includes: a detector that detects a characteristic of a sheet transported by a transport module; an amplifier that amplifies a signal obtained from the detector; an analog-to-digital converter (A/D converter) that converts an analog signal amplified in the amplifier to a digital signal; determining means that determine the truth of the sheet by use of a signal having been produced as a result of A/D conversion by the A/D converter; and a control part that changes signal read accuracy of the detector. With this construction, if a sheet is determined as unidentified in the determining means, the control part changes a setting of conditions so that a capability to determine the sheet is higher, and transports the sheet determined as unidentified to the detector so that the truth determination is performed again in the determining means.

In a preferred example, the control part changes the amplification factor of the amplifier or the input range of the A/D converter. For example, it is desirable that the amplification factor is changed correspondingly to the denominations of bills.

The present invention is also grasped as a method of determining bills. A method of determining bills in a bill handling apparatus, including the steps of: sending a bill to a determining part to perform determination; detecting characteristics of the bill by a detector; processing a signal from the detector and determining the truth of the bill; as a result of the truth determination, classifying the bill into one of at least four types of bills to process the bill, the four types of bills being true bills determined as true, false bills lacking characteristics indispensable to true bills, unidentified bills having characteristics indispensable to true bills but exceeding a permissible error thereof, and undefined bills the denominations of which cannot be determined; if the bill is determined as an unidentified bill, changing a signal amplification factor or resolution of the detector so as to increase accuracy to determine the bill; and after the change, sending the unidentified bill to the determining part again to detect the characteristics of the bill in the detection part.

### BRIEF DESCRIPTION OF THE DRAWINGS

FIG. 1 is a structural drawing of an ATM according to an embodiment of the present invention;

FIG. 2 is a drawing showing a sample configuration of a bill determining part of the ATM;

FIGS. 3A and 3B are output waveform drawings of an amplifier of the determining part;

FIGS. 4A and 4B are an output waveform drawings of the amplifier of the determining part according to another embodiment;

FIGS. 5A, 5B, 5C, and 5D are output waveform drawings of the amplifier of the determining part according to an embodiment of the present invention, and output waveform drawings of the amplifier after A/D conversion;

FIG. 6 is an operation flowchart of bill determining processing according to an embodiment of the present invention;

FIG. 7 is an operation flowchart of bill determining processing according to another embodiment of the present invention;

FIG. 8 is an operation flowchart of bill determining processing according to another embodiment of the present invention;

FIG. 9 is a structural drawing of the ATM according to another embodiment of the present invention;

FIG. 10 is an operation flowchart of bill determining processing according to another embodiment of the present invention; and

FIG. 11 is an operation flowchart of bill determining processing according to another embodiment of the present invention.

### DETAILED DESCRIPTION OF THE PREFERRED EMBODIMENT

Hereinafter, the present invention is described using embodiments.

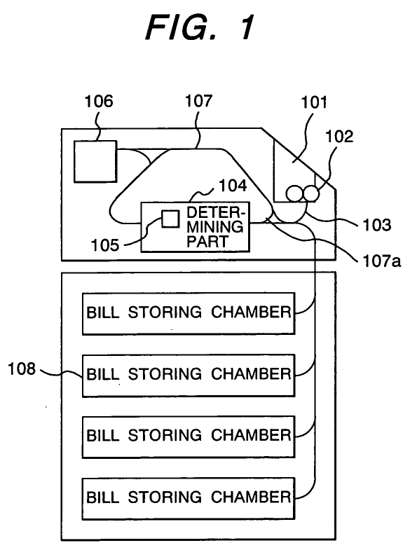

FIG. 1 is a drawing showing the configuration of an ATM according to an embodiment of the present invention.

In the drawing, 101 indicates a deposit/withdrawal part that is a place where an ATM user inputs bills. 102 indicates a bill separating part that separates inputted bills one by one. 103 indicates a transport path through which bills are transported. 104 indicates an determining part that determines the denomination of a bill and whether it is true or false. 105 indicates a sensor such as an optical sensor and a magnetic sensor placed within the determining part 104 to detect the characteristics of bills. 106 indicates a temporary stocking part for temporarily holding bills. 107 indicates a return transport path (simply referred to as a transport path) for returning a bill to the ATM user. 108 indicates a bill storing chamber (hereinafter simply referred to as a storing chamber) for storing bills. The storing chamber 108 consists of plural storing chambers, and according to the result of checking a bill in the determining part 104, the bill is stored in one of the storing chambers for reject bills, 1,000-yen bills, 5,000-yen bills, and 10,000-yen bills. For an ATM of circulation type, bills not circulated are stored in the storing chamber for rejected bills, and bills used for circulation are stored in the storing chambers for 1,000-yen to 10,000-yen bills. The transport path 107a is a transport path in the vicinity of the deposit/withdrawal part 101, as shown in the drawing, and particularly indicates a portion transporting unidentified bills described later during redetermination.

During deposit transaction, when the ATM user inputs one or plural bills to the deposit/withdrawal part 101, the bill separating part 102 installed in the deposit/withdrawal part 101 separates the bills one by one. The separated bills are sent to the determining part 104 through the transport path 103. The determining part 104 detects the characteristics of the bill by the sensor 105 and determines the denomination of the bill and whether it is true or false, from the characteristics of the bill. According to the determination result in the determining part 104, the bill is classified to one of the four types of true bills, false bills, unidentified bills, and undefined bills.

True bills are bills determined to be true. False bills are bills lacking the characteristics of true bills. Unidentified bills are bills that have the characteristics of true bills but are out of the range of a permissible error. Undefined bills are bills whose denomination cannot be determined, and include transport errors, bent bills, torn bills, and the like.

Processing of the unidentified bills is characteristically performed in the present embodiment. The unidentified bills are those determined to be out of a permissible range because of dirty bills or variations in the sensitivity and the performance capabilities of the sensor of the determining part though they were determined to be within a permissible range with respect to the sizes of 1,000-yen, 5,000-yen, and 10,000-yen bills and their designs.

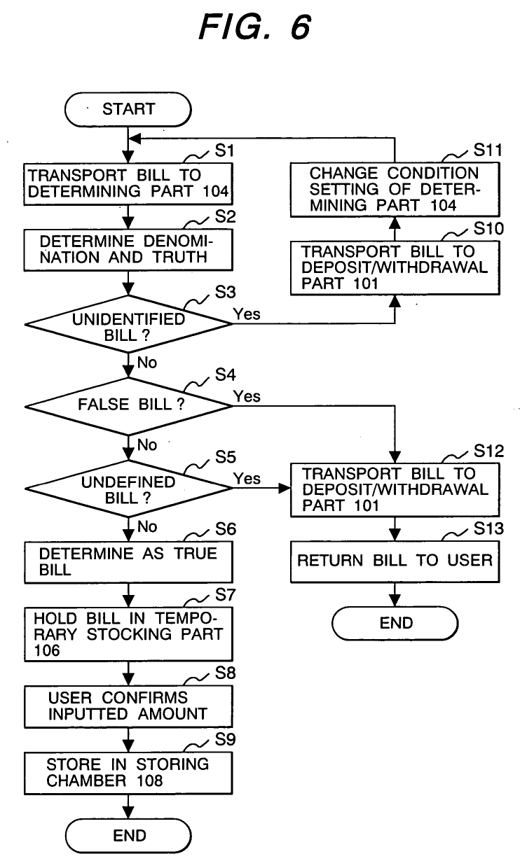

Next, a description is made of the operation of the determining processing for bills classified to the abovementioned four types with reference to the flowchart of FIG. 6.

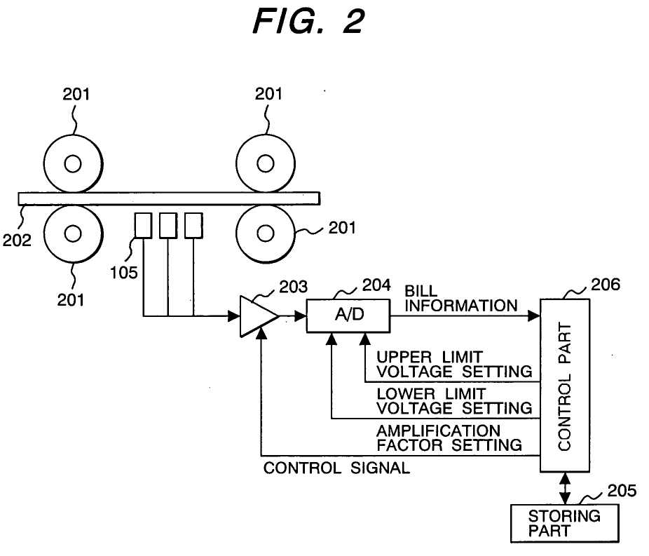

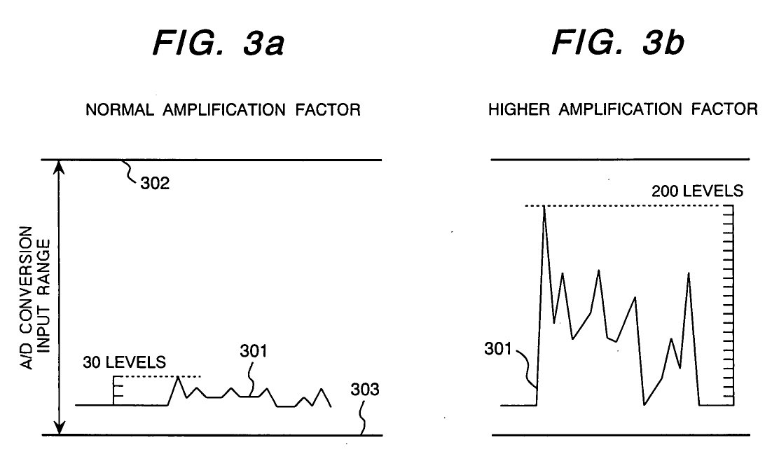

Bills set in the deposit/withdrawal part 101 are separated one by one in the separating part 102, and transported to the determining part 104 (S1). The determining part 104 determines the denomination of the bills and whether they are true or false (first mode) (S2). A bill determined as an unidentified bill by the truth determination is transported to the deposit/withdrawal part 101 through the return transport path 107 (S10). According to the present embodiment, the condition setting of the sensor of the determining part 104 is changed so that the capability to determine bills becomes higher, in other words, the detection accuracy of the sensor becomes higher (S11), and a bill determined as an unidentified bill is determined again in the determining part 104. An example of condition change in step S11 will be described later with reference to FIGS. 2 and 3. The bill returned to the vicinity of the deposit/withdrawal part 101 is transported to the determining part 104 again through the transport path 107a (S1), where it is again checked for its denomination and to see whether it is true or false (second mode). If the bill is determined as a false or undefined bill by the truth determination (the first mode and the second mode) in the determining part 104, the bill is transported to the deposit/withdrawal part 101 and returned to the user (S12, S13). If it is determined as a true bill in the determining part 104 (S6), the bill is temporarily held in the temporary stocking part 106 (S7). When the user refers to a total amount displayed on the guidance screen and inputs confirmation of an inputted amount, the bills are stored in the bill storing chamber 108 (S9). If the user selects cancellation on the guidance screen, the bills temporarily stored in the temporary stocking part 10 are returned to the deposit/withdrawal part 101 (the following is the same as the above).

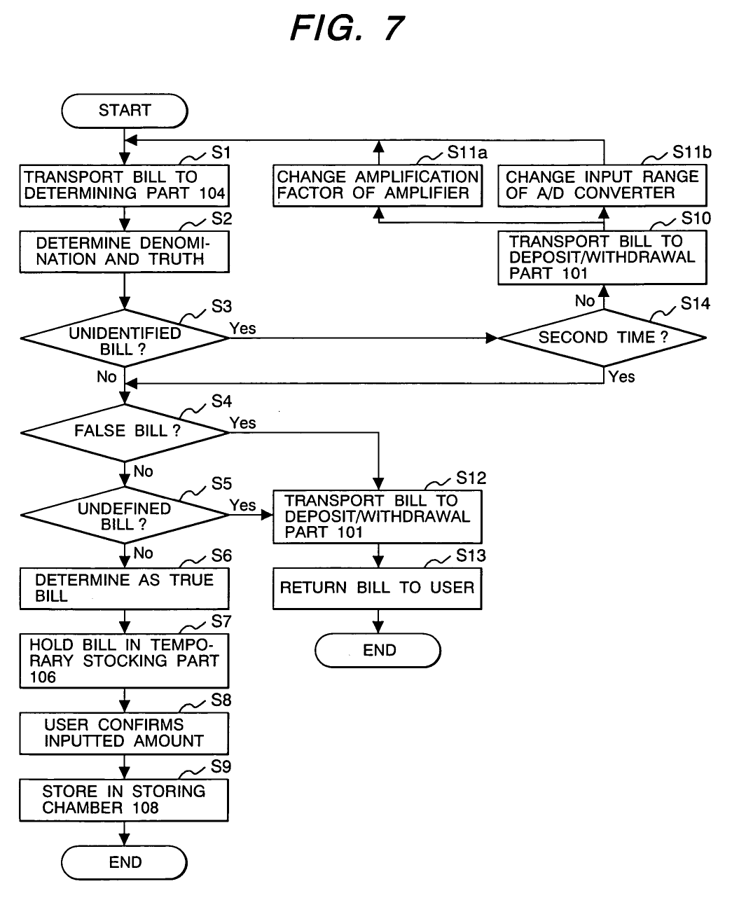

Next, referring to the flowchart of FIG. 7, a description is made of the operation of the determining processing for the bills classified to the abovementioned four types. The determining processing denotes another embodiment and the same reference numerals are assigned to the same steps as those in FIG. 6. Characteristic points are that unidentified bills are counted (S14), and changes of the condition settings of the determining part are different (S11a, S11b).

Bills set in the deposit/withdrawal part 101 are separated one by one in the separating part 102, and transported to the determining part 104 (S1). The determining part 104 determines the denomination of the bills and whether they are true or false (first mode) (S2). A bill determined as an unidentified bill by the truth determination is transported to the deposit/withdrawal part 101 through the return transport path 107 (S12). According to the present embodiment, the condition setting of the sensor of the determining part 104 is changed so that the capability to determine bills becomes higher, in other words, the detection accuracy of the sensor become higher (S11a, S11b), and a bill determined as an unidentified bill is checked again in the determining part 104. An example of condition change in step S11a or S11b will be described later with reference to FIGS. 2 and 3. The bill returned to the deposit/withdrawal part 101 is transported to the determining part 104 again (S1), where it is again checked for its denomination and to see whether it is true or false (second mode). If the bill is determined as a false or undefined bill by the truth determination (the first mode and the second mode) in the determining part 104, the bill is transported to the deposit/withdrawal part 101 and returned to the user (S12, S13). If it is determined as a true bill in the determining part 104 (S6), the bill is temporarily held in the temporary stocking part 106 (S7). When the user refers to a total amount displayed on the guidance screen and inputs confirmation of an inputted amount, the bills are stored in the bill storing chamber 108 (S9).

If the bill is determined as an unidentified bill in the second mode, that is, it is determined as an unidentified bill again as a result of the re-determination (S14), the bill is not transported again to the deposit/withdrawal part 107 and control proceeds to false/undefined bill determination steps (S4, S5), where the bill is returned to the user as a false or undefined bill. The deposit/withdrawal part 101 has a facility that separates bills before the first mode is applied from bills determined as unidentified bills, False bills, and undefined bills in the first mode (or the second mode), thereby preventing coexistence of the former and the latter. In the aforementioned embodiments, all bills determined as unidentified bills, false bills, and undefined bills in the first mode are transported to the deposit/withdrawal part 101. However, all of them may be transported again in the second mode, or only unidentified bills may be transported in the second mode, and false bills and undefined bills may not be transported in the second mode.

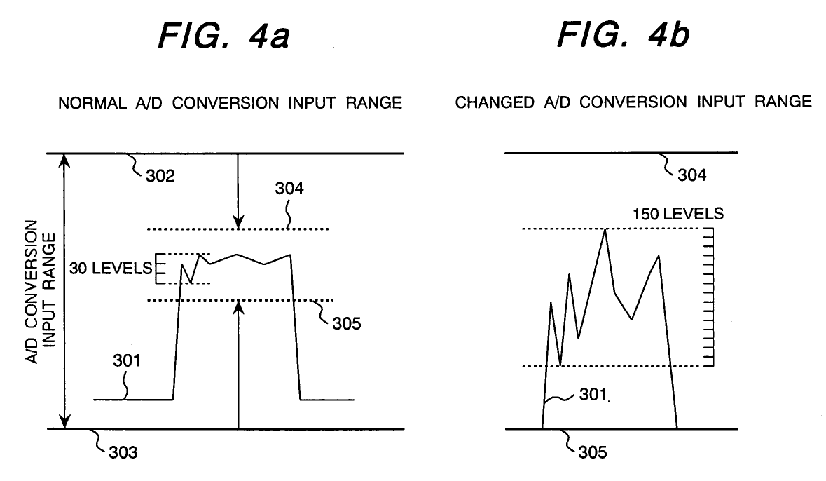

The aforementioned embodiments describe a method for increasing determination accuracy in the case where bills stored in the storing chamber 108 are limited to True bills. Instead of returning undefined bills to the user in the example of FIG. 4, a storing chamber may be provided to store the undefined bills. For example, one of the plural storing chambers 108 may be used for undefined bills.

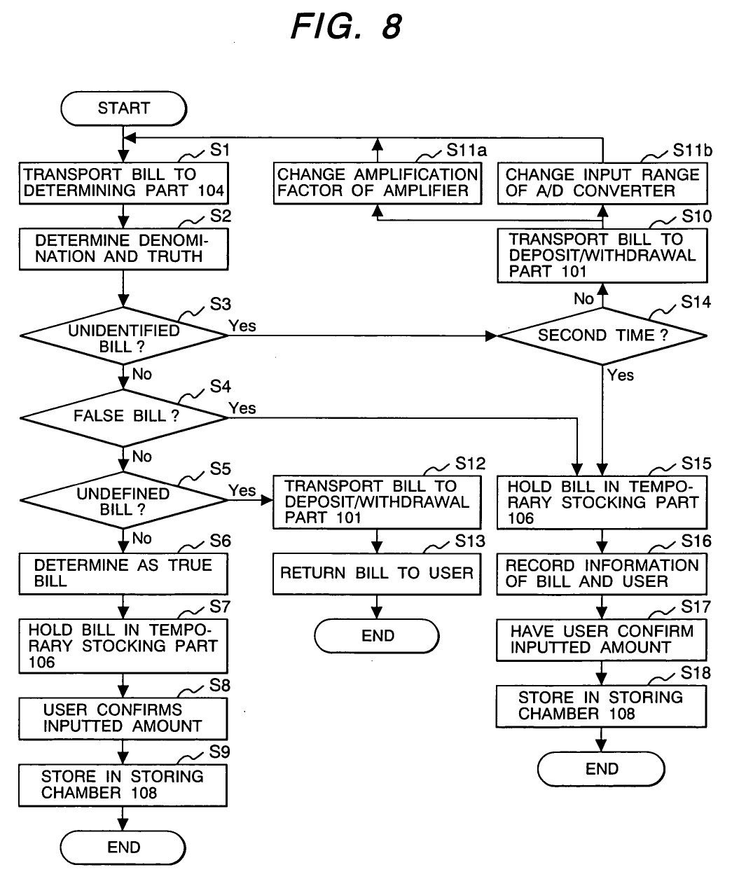

Next, referring to the flowchart shown in FIG. 8, a description will be made of another embodiment of bill determining processing. The same reference numerals are assigned to the same steps as those in FIG. 6. This embodiment is different from the example of FIG. 6 in that steps 15 to 18 are added.

Like FIG. 6, bills set in the deposit/withdrawal part 101 are separated one by one in the separating part 102, and transported to the determining part 104 (S1). The determining part 104 determines the denomination of the bills and whether they are true or false (S2). A bill determined as an unidentified bill by the truth determination is transported to the deposit/withdrawal part 101 (S10). At the same time, the condition setting of the determining part 104 is changed (S11a, S11b). The bills are transported again to the determining part 104 (S1). Conditions in the determining part 104 are changed by changing the amplification factor of an amplifier (S11a) or changing input ranges of an A/D converter (S11b). If the bill is determined as an unidentified bill again as a result of bill redetermination, the bill is stored in the temporary stocking part 106 (S15). After information about the bills and the user is recorded in a storing part 205 (FIG. 2) (S16), an inputted amount is confirmed by the user (S17), and the bills are stored in the storing chamber 108 (S18).

Also when the bill is determined as a false bill, the procedure from S15 to S18 is executed similarly. A bill determined as an undefined bill in the determining part 104 is transported to the deposit/withdrawal part 101 (S12) and returned to the user (S13). A bill determined as a true bill in the determining part 104 (S6) is temporarily held in the temporary stocking part 106 (S7). After the user confirms an inputted amount input (S8), the bills are stored in the storing chamber 108 (S9).

In the aforementioned embodiment shown in FIG. 8, False bills and unidentified bills are not returned to the user, and the contents stored in the storing part 205 can be used to trace and locate the user of the False bills at a later date. False bills and unidentified bills may be separately stored in the storing chamber 108. Although, in the second embodiment, bills determined as unidentified bills again as a result of redetermination are handled as unidentified bills, the number of redeterminations may be increased to three, four, or more.

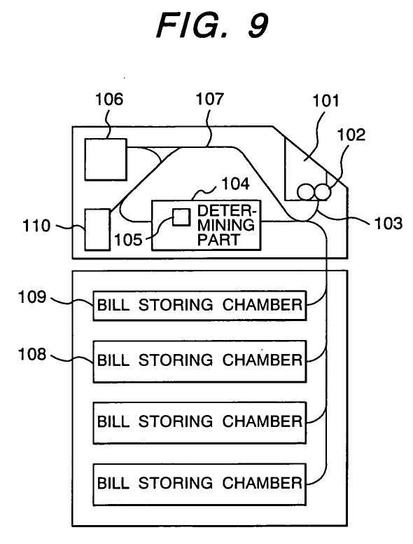

Next, referring to the configuration of the ATM shown in FIG. 9, a description will be made of another embodiment. The same reference numerals are assigned to the same components as those in FIG. 1. This embodiment is different from the example of FIG. 1 in that components 109 and 110 are added. With the machine of FIG. 1, during redetermination, a bill is transported using the transport path (107a) in the vicinity of the deposit/withdrawal part 101. However, with the machine of FIG. 9, the transport construction is simplified by omitting the transport path.

In the drawing, 101 indicates a deposit/withdrawal part that is a place where an ATM user inputs bills. 102 indicates a bill separating part that separates inputted bills one by one. 103 indicates a transport path through which bills are transported. 104 indicates a determining part that determines the denomination of a bill and whether it is true or false. 105 indicates a sensor placed within the determining part 104 to detect the characteristics of bills. 106 indicates a temporary stocking part for temporarily holding bills. 107 indicates a return transport path for returning a bill to the ATM user. 108 indicates a bill storing chamber for storing bills. 109 indicates a reject bill storing chamber for storing bills not suitable for circulation. 110 indicates a false bill storing chamber that stores bills determined as False bills by the determining part 104.

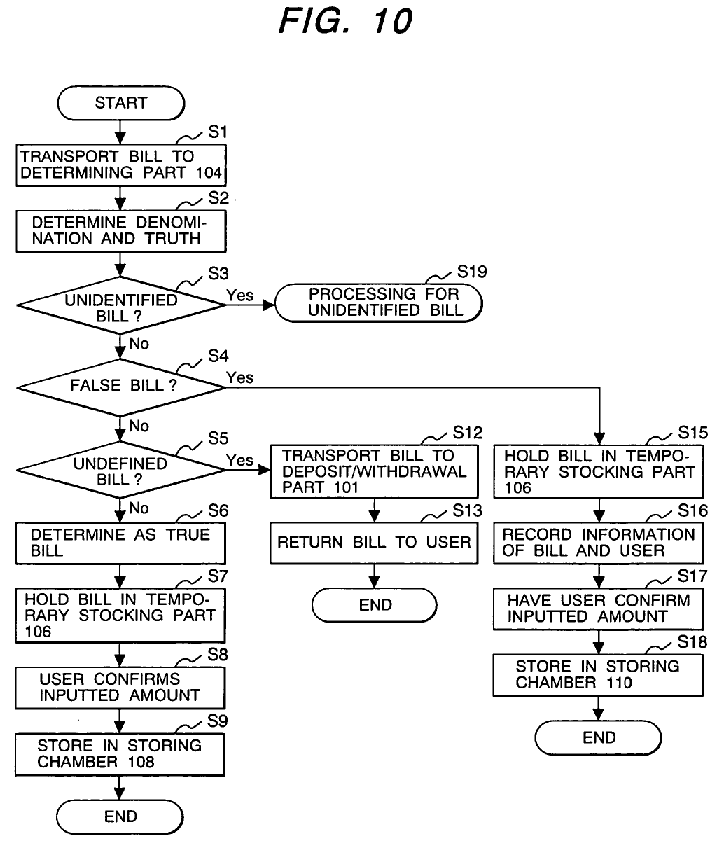

Next, referring to the flowchart shown in FIG. 10, a description is made of an embodiment of bill determining processing in the ATM configuration of FIG. 9. The same reference numerals are assigned to the same steps as those in FIG. 8. This embodiment is different from the example of FIG. 8 in that the step 18 is changed and processing for determination as an unidentified bill is performed in step 19.

Like FIG. 8, bills within the deposit/withdrawal part 101 are separated one by one in the separating part 102, and transported to the determining part 104 (S1). The determining part 104 determines the denomination of the bills and whether they are true or false (S2). If a bill is determined as an unidentified bill by the truth determination, unidentified bill processing shown in FIG. 10 is performed (S19). The unidentified bill processing will be described later. If the bill is determined as a false bill in the determining part 104, the bill is held in the temporary stocking part 106 (S15). After information of the bill and the user is stored in the storing part 205 (S16), an inputted amount is confirmed by the user (S17) and the bills are stored in the storing chamber 110 (S18).

If the bill is determined as an undefined bill in the determining part 104, the bill is transported to the deposit/withdrawal part 101 (S12) and returned to the user (S13). A bill determined as a true bill in the determining part 104 is temporarily held in the temporary stocking part 106 (S7), and after an inputted amount is confirmed by the user (S8), the bills are stored in the storing chamber 108 (S9).

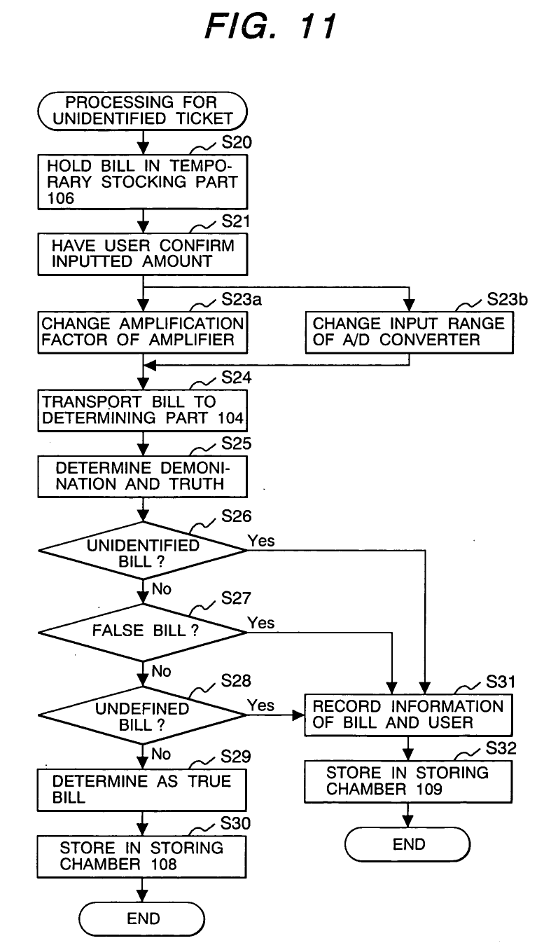

Next, referring to the flowchart shown in FIG. 11, a description will be made of unidentified bill processing in the step S19 of FIG. 10. If the bill is determined as an unidentified bill in the determining part 104, the bill is held in the temporary stocking part 106 (S20), and an inputted amount is confirmed by the user (S21). Next, as in the case of FIG. 8, the amplification factor of the amplifier is changed (S23a), the input range of the A/C conversion part is changed (S23b), and conditions of the determining part 104 are changed. The bill is transported to the determining part 104 (S24), where it is checked for its denomination and to see if it is true or false (S25). In the machine layouts of FIGS. 1 and 9, the transport path between the temporary stocking part and the determining part allows forward and backward transport of bills, and the transport path connecting the determining part and the storing chamber also allows forward and backward transport of bills.

If the bill is determined as a false bill or an unidentified bill in step S25, information of the bill and the user is stored (S31), and the bill is stored in the storing chamber 109 (S32). Bills stored in the storing chamber 109 are not used as bills for payment. Bills determined as true bills are stored in the storing chamber 108 (S30) and used as bills for payment.

In the embodiment shown in FIGS. 9 and 10, since unidentified bills are subjected to redetermination without transporting them to the deposit/withdrawal part 101, the time for bill input processing can be reduced, compared with the case of FIG. 8, with the result that the convenience of the ATM rises.

Next, referring to the sample configuration of the determining part 104 shown in FIG. 2, a description is made of the change of detection conditions during bill redetermination.

In FIG. 2, rollers 201 transport a bill 202 while pinching it at both sides. Plural detectors 105 detect the characteristics of the bill 202. There are various types of detectors 105, such as those that shine light on a bill from the source of light to detect reflected light from the bill, those that detect transmitted light of a bill, those that detects magnetic ink printed on a bill, and those that detect the thickness of a bill; the present embodiment is not limited to specific detectors. Plural pieces of these detectors may be combined for use. 203 is an amplifier that amplifies an analog signal detected from the detector 105. The amplifier 203 can change the amplification factor by a control signal from the control part 206. The output signal of the amplifier 203 is converted to a digital signal by the A/D converter 204. The control part 206 controls the amplifier 203, the A/D converter 204, and the storing part 205.

The digital signal from the A/D converter 204 is bill information including image information and stored in the storing part 205. When a larger voltage than the upper limit value of the A/D converter 204 is inputted, the upper limit value is outputted from the A/D converter, and when a smaller voltage than the lower limit value is inputted to the A/D converter 204, the lower limit value is outputted. The input between the upper limit value and the lower limit value is converted to a digital signal by the A/D converter 204 and outputted.

The control part 206 determines the denomination and the truth of the bill by use of the bill information stored in the storing part 205. Thereafter, a deposit operation is performed with a bill transaction machine by use of denomination information and truth information obtained in the control part 206.

Next, a description is made of an example of changing the detection condition of the determining part 104.

FIG. 3 shows an example of changing the amplification factor of the output signal of the sensor. The vertical axis of the drawing indicates output voltages from the amplifier 203, and the horizontal axis indicates the positions of a transported bill. 301 indicates output voltages of the amplifier 203. 302 indicates the upper limit value of the input voltages of the A/D converter 204, and 303 indicates the lower limit value of the input voltages of the A/D converter 204. A normal amplification factor is set so that the output voltages of the bills of all denominations to be handled fall between the upper limit value 302 and the lower limit value 303. Such setting enables the control part 206 to determine the truth without the output of the A/D converter 204 being saturated, even for bills for which large output voltages are generated.

However, when this amplification factor is used, for small denominations for which small output voltages are generated, only one part of the range between the upper limit voltage and the lower limit voltage is used, as shown in FIG. 3A. Since the A/D converter 204 divides the range between the upper limit voltage and the lower limit voltage to a predetermined number (e.g., 256 for 8-bit A/D converter), the level of a weak signal becomes small and the resolution becomes small.

Accordingly, the resolution is increased in the present embodiment. Specifically, when a bill transported with the amplifier 203 set at a normal amplification factor is determined as an unidentified bill and subjected to redetermination, the amplifier 203 is set to an amplification factor corresponding to a denomination determined from denomination determination. In this case, as shown in FIG. 3B, output voltages becomes larger and the resolution improves. As a result, the characteristics of bills can be detected more accurately and the determination capability improves. An output voltage of 30 levels as shown in FIG. 3A before the amplification factor is changed is increased to 200 levels as shown in FIG. 3B after the amplification factor is changed, as shown in FIG. 3B, so that an area determined as true bills can be set in detail and determination accuracy improves.

Next, referring to FIG. 4, a description will be made of another example of changing the detection condition of the determining part 104.

Preferably, this example is applied to bills for which an amount of output of the amplifier 203 is obtained, as shown in FIG. 3A. For such bills, since the output voltage of the amplifier 203 cannot exceed the upper limit voltage 302, the amplification factor cannot be set so high. Therefore, the aforementioned method yields only small improvement effects. On the other hand, the method of FIG. 4 changes the input upper limit voltage 302 and the lower limit voltage 303 of the A/D converter.

In FIG. 4, like FIG. 3, the vertical axis indicates output voltages from the amplifier 203, and the horizontal axis indicates the positions of a transported bill. 304 indicates a value newly set as the upper limit voltage 302 by the control part 206, and 305 indicates a value newly set as the lower limit voltage 303 by the control part 206. The output voltages of the amplifier 203 when the portion between the upper limit value 304 and the lower limit value 305 as shown in FIG. 4A is set as an A/D conversion input range are shown in FIG. 4B. For a bill in FIG. 4A having a significant range of 30 levels as bill information, the significant range is expanded to 150 levels as shown in FIG. 4B by narrowing the range between the input upper limit value 304 and the lower limit value 305 of the A/D converter. By performing such setting, the detailed characteristics of the bill can be obtained and the determination accuracy improves.

As described above, the condition change during redetermination in the present invention is made in a form that inputs a bill determined once to the determining part again and changes how to process obtained data. Although a method is conceivable which processes bill data obtained by the first bill transport by operations and performs determination again based on the processed data, the present invention does not employ the method. In short, this is because that the method would fail to increase the accuracy of bill data.

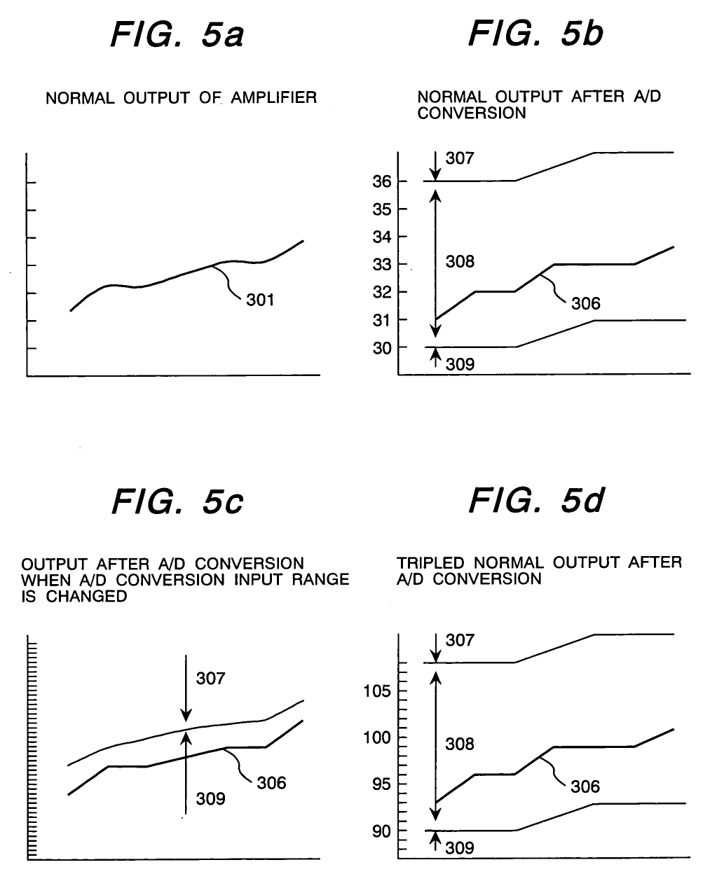

This is described with reference to FIG. 5. In the drawing, 301 indicates the output voltages of the amplifier. 306 indicates values produced by converting the output voltages of the amplifier by the A/D converter. 307 indicates an area determined as true bills, and if a value produced by A/D conversion falls in this area, the control part 206 determines the bill as a true bill. 308 indicates an area determined as unidentified bills, and if a value produced by A/D conversion falls in this area, the control part 206 determines the bill as an unidentified bill. 309 indicates an area determined as false bills, and if a value produced by A/D conversion falls in this area, the control part 206 determines the bill as a false bill. FIG. 5A shows the output voltages of the amplifier when bills are transported at a normal amplification factor. The output voltages are converted as shown in FIG. 5B by A/D conversion. Since the A/D converter converts the output voltages of the amplifier to discrete values, the values 306 produced by the A/D conversion cannot correctly reflect the output 301 of the amplifier, causing an error. If the degree of the error and the magnitude of a bill signal are closer to each other, it becomes more difficult to determine bills.

Since the values 306 produced by A/D conversion are in the area 308 determined as an unidentified bill as shown in FIG. 5B, the bill is determined as unidentified, and in embodiments of FIGS. 7, 8, and 11, the bill is transported again. If the input range of the A/D converter is changed when the bill is transported, the output as shown in FIG. 5C is obtained. Specifically, by narrowing the A/D conversion input range, the scale of the vertical line (Y axis) of FIG. 5C becomes narrow and, as a result, converted discrete values become finer as shown in FIG. 5C. Therefore, the values 306 produced by the A/D conversion are closer to the output voltages 301 of the amplifier in comparison with FIG. 5B. This means that information about the bill has been obtained more faithfully. The boundary between the area determined as true bills and the area determined as false bills can be set finer, and the determination capability can be increased.

On the other hand, a method is conceivable which converts the values of FIG. 5B obtained during the first transport in the control part 206 to perform redetermination. However, this method cannot increase the accuracy of values produced by A/D conversion. In short, data obtained once cannot be processed into detailed data. For example, as shown in FIG. 5D, making multiplication by a constant (three times) within the control part 206 results in the output value being only tripled (see the scale of the Y axis); detailed bill information cannot be obtained.

Since the present invention increases the resolution of sensor output, the determination accuracy can be increased without changing a major change to a determination method and the development of an determination algorithm is eased. The determining part does not need to be optimized to specific denominations and the identical determining part can apply to many denominations, increasing the versatility of the machine.

In the aforementioned embodiments, the examples shown in the flowcharts of FIGS. 7, 8, and 11 show the method of changing the amplification factor of the amplifier (S11a), and the method of changing the input range of the A/D converter (S11b) to increase the capability to determine bills. However, both or only one of the S11a and S11b may be adopted as control targets of condition change.

The present invention, without being limited to sheet handling apparatus such as the aforementioned ATM, can also apply to other sheet handling apparatus such as cash exchange machines for lottery bills, and machines for determining the truth of lottery bills and checks in check handling machines.

According to the present invention, by changing the resolution of the determining part for sheets determined as unidentified as a result of determining the truth of sheets, the capability to determine the sheets can be increased. Also, by subjecting unidentified sheets to the determination process again, the capability to reject false bills can be increased.

What is claimed is:

1. A sheet handling apparatus comprising:
a detection part that detects a characteristic of a sheet transported by a transport module;
an amplifier that amplifies a signal obtained from the detection part;
an A/D converter that converts an analog signal amplified in the amplifier to a digital signal;
determining means that determine the truth of the sheet by use of a signal having been produced as a result of A/D conversion by the A/D converter; and
a control part that changes signal read accuracy of the detection part,
wherein, if the sheet is determined as unidentified as a result of determining the truth of the sheet in the determining means, the control part changes a setting of conditions so that a capability to determine the sheet is higher than when the sheet was determined as unidentified, and transports the sheet determined as unidentified to the detection part so that the truth determination is performed again in the determining means.

2. The sheet handling apparatus according to claim 1,
wherein the control part changes an amplification factor of the amplifier.

3. The sheet handling apparatus according to claim 1,
wherein the control part changes the amplification factor of the amplifier correspondingly to denominations.

4. The sheet handling apparatus according to claim 1,
wherein the control part changes an range between an input upper limit value and an input lower limit value of the A/D converter.

5. The sheet handling apparatus according to claim 3,
wherein the control part sets conditions so as to narrow the range between the upper limit value and the lower limit value of the A/D converter.

6. The sheet handling apparatus according to claim 1,
wherein sheets determined as unidentified by the determining means include sheets in which characteristics indispensable to true bills were detected but which exceed a permissible error.

7. A method of determining bills in a bill handling apparatus, comprising the steps of:
sending a bill to a determining part to perform determination;
detecting characteristics of the bill by a detection part;
processing a signal from the detection part and determining a denomination and truth of the bill;
as a result of the truth determination, classifying the bill into one of at least four types of bills to process the bill, the four types of bills being true bills determined as true, false bills lacking characteristics indispensable to true bills, unidentified bills having characteristics indispensable to true bills but exceeding a permissible error thereof, and undefined bills the denominations of which cannot be determined;
if the bill is determined as an unidentified bill, changing an amplification factor or resolution of the detection part so as to increase accuracy to determine the bill; and
after the change, sending the unidentified bill to the determining part again to detect the characteristics of the bill in the detection part.

8. The determination processing method according to claim 7,
wherein the changing step changes an input range of the A/D converter.

9. The determination processing method according to claim 7,
wherein, as a result of the truth determination, an undefined bill is returned to a user, a bill determined as an unidentified bill and a bill determined as a false bill in another determination are stored in the machine, and a bill determined as an undefined bill in yet another determination is returned to the user.

10. A sheet handling apparatus, comprising:
a determining part that determines the truth of sheets transported by a transport module;
a control part that changes accuracy to determine the sheets in the determining part; and
a stocking part that temporary holds sheets determined as unidentified in the determining part,
wherein, if the sheets are determined as unidentified in the determining part, the control part changes a determination condition so as to increase the determination accuracy of the determining part, and transports the sheets determined as unidentified to the determining part again to determine the truth of the sheets.

11. The sheet handling apparatus according to claim 10,
wherein the determining part comprises: a detector that detects a characteristic of a sheet, an amplifier that amplifies a signal obtained from the detector, an A/D converter that converts an analog signal amplified in the amplifier to a digital signal; and determining means that determine the truth of the sheets by use of a signal produced as a result of A/D conversion by the A/D converter,
wherein, if the sheet is determined as unidentified in the determining part, the control part changes signal read accuracy of the detector so as to increase a capability to determine the sheet, and transports the sheet determined as unidentified to the detector to again determine the truth of the sheet in the determining means.

12. The sheet handling apparatus according to claim 10,
wherein the sheet handling apparatus includes a storing part that stores contents of sheet transactions by users, and stores information about sheets determined as false bills or unidentified bills as a result of another determination by the determining part in the storing part in association with information capable of identifying the users.

13. The sheet handling apparatus according to claim 12, including a storing chamber for storing the false bills or unidentified bills in the machine without returning them to the users.

14. The sheet handling apparatus according to claim 11,
wherein the control part changes an amplification factor of the amplifier.

15. The sheet handling apparatus according to claim 11,
wherein the control part changes an input range of the A/D converter.

16. A method of determining bills in a bill handling apparatus, comprising:
transporting bills to an determining part to perform determination;
a first determination mode in which denominations and truth of the bills are determined with first determination accuracy in the determining part;
setting second determination accuracy as higher bill determination accuracy if a bill is determined as an unidentified bill as a result of determination in the first determination mode;
a second determination mode in which a bill determined as unidentified as a result of the first determination in the determining part set at the second determination accuracy is determined again; and
processing bills determined as unidentified or false bills as a result of determination in the second determination mode separately from other bills.

17. The method of determining bills according to claim 16,
wherein the first determination mode includes the steps of:
detecting the characteristics of the bills by a detector; and
processing a signal from the detector to determine the truth of the bills.

18. The method of determining bills according to claim 16, setting accuracy so as to increase the amplification factor or resolution of the detector for detecting the characteristics of the bills in the second determination mode.

19. The method of determining bills according to claim 16, including the step of storing information about sheets determined as false bills or unidentified bills in the second determination mode in a storing part in association with information capable of identifying users of the bills.

20. The method of determining bills according to claim 16, further including the step of having users confirm an inputted amount if a bill is determined as an unidentified bill as a result of determining the bill in the first determination mode.
